(19) United States
(12) Patent Application Publication
(10) Pub. No.: US 2026/0264604 A1
(43) Pub. Date: Sep. 10, 2026

(54) LIGHTING DEVICE ON A VEHICLE DOOR OF A MOTOR VEHICLE

(71) Applicant: Kiekert Aktiengesellschaft, Heiligenhaus (DE)

(72) Inventors: Tobias KLOCKE, Mettmann (DE); Steve BREUNINGER, Gauting (DE)

(73) Assignee: Kiekert Aktiengesellschaft, Heiligenhaus (DE)

(21) Appl. No.: 19/165,643

(22) PCT Filed: Mar. 19, 2024
(86) PCT No.: PCT/DE2024/100227

§ 371 Date: Sep. 16, 2025

(30) Foreign Application Priority Data
Mar. 20, 2023 (DE) 10 2023 106 887.3

(51) Int. Cl. B60Q 1/24; B60Q 1/00; F21S 43/241; F21S 43/31; F21V 9/14; F21W 103/60

(52) U.S. Cl. CPC B60Q 1/247; B60Q 1/0011; F21S 43/241; F21S 43/31; F21V 9/14; F21W 2103/60

(57) ABSTRACT

A lighting device on a vehicle door of a motor vehicle, includes an illuminating means, a light guide which can be connected to the illuminating means, and an imaging means, wherein by means of the lighting device a variable display can be generated, and wherein the lighting device is arranged at least partly in an operating element which can be moved out of the vehicle.

The invention relates to a lighting device on a motor vehicle door of a motor vehicle having an illuminating means, a light guide which can be connected to the illuminating means and an imaging means, wherein by means of the lighting device a variable display can be generated.

When motor vehicles are used in road traffic, they are subject to a number of safety regulations. In particular, the lighting of a motor vehicle has become more and more important in recent years. Thus, today's vehicles are already equipped with driving lights that, independently of the low beam used when driving in the dark, illuminate the vehicle even during the day and thereby make it more visible to other road users. Thus, the light on a motor vehicle represents a safety-relevant feature.

In order to further increase safety and comfort for the driver and/or other road users, it is also known to design an opening door or flap of a motor vehicle with an illuminating means, reflectors or luminescent components, so that the movements on the motor vehicle can be displayed to another road user by means of a light effect.

In order to increase comfort in a motor vehicle, it has become known from DE 103 03 514 A1 to arrange a lighting device on a vehicle door, which has a light guide connected to a light source and a support element to be fastened to the vehicle door. The light source is fastened to the support element, wherein the guide has an electrical line leading to the support element, which can be introduced with its free end through a passage opening in the vehicle door into an interior region of the vehicle door and can be connected to a power line. By integrating a lighting device into a vehicle handle in this way, it is possible to generate puddle lighting on the vehicle.

As a further piece of prior art, which in turn increases comfort in the motor vehicle, reference may be made to DE 10 2016 105 997 A1. The publication relates to a locking device for a motor vehicle, in particular a motor vehicle lock, having a housing, an illuminating means and at least one light guide element, wherein light can be introduced into the light guide element by means of the illuminating means and wherein light can be guided and emitted into a surrounding area of the locking device by means of at least one light guide element. In addition, an imaging means can be arranged on the light guide element, so that information on the condition of the motor vehicle can be displayed to the driver. For projecting the display, information is projected onto a side wall and/or a B-pillar of a motor vehicle, for example.

In principle, display means or illuminating means known from the prior art for use in a vehicle door of a motor vehicle have proven themselves, but reach their limits when, for example, information about the unopened motor vehicle is to be provided, or when, in addition to pure illumination, additional information is to be transmitted to the operator. In particular, safety-relevant features or information that facilitates the operation of the motor vehicle can then not be transmitted to the operator. This is where the invention comes in.

An object of the invention is to provide an improved lighting device on a motor vehicle door that overcomes the disadvantages of the prior art. Furthermore, it is an object of the invention to provide a lighting device that provides the operator with clear instructions for operating the motor vehicle and at the same time provides means for operating it. Furthermore, it is an object of the invention to provide a cost-effective and structurally simple system for providing vehicle information.

According to the invention, the object is achieved by the features of independent claim 1. Advantageous embodiments of the invention are specified in the dependent claims. It should be noted that the exemplary embodiments described below are not restrictive; rather, any variation of the features described in the description and the dependent claims is possible.

According to claim 1, the object of the invention is achieved in that a lighting device is provided on a vehicle door of a motor vehicle, having an illuminating means, a light guide which can be connected to the illuminating means and an imaging means, wherein by means of the lighting device a variable display can be generated and wherein the lighting device is arranged at least partly in an operating element which can be moved out of the vehicle. The structure of the lighting device according to the invention now creates the possibility of transmitting information to the operator or user of the motor vehicle even when the vehicle is locked and at the same time of providing an operating element. The lighting device is at least partially integrated into the operating element, so that after the operating element is moved out, information on the operation and/or status of the motor vehicle can be provided by the operating element itself. For this purpose, the lighting device is capable of transmitting information to the user of the motor vehicle from the operating element itself. This is particularly due to the fact that an imaging means is assigned to the lighting device, so that variable information can also be transmitted to the user. In particular, the imaging means can display to the user information on, for example, the status of the motor vehicle. For example, if an operator with authorization approaches the motor vehicle, the operating element can be moved out of the motor vehicle and information can be projected onto the motor vehicle by means of the lighting and display device. It is conceivable, for example, that an outer door handle is moved out of the motor vehicle when the operator approaches the motor vehicle and a status display is transmitted to the user by means of the lighting and display device. The status display can, for example, indicate to the user that the vehicle is ready to be opened or it can also provide safety instructions, for example that a tailgate has not yet been locked. The lighting and display device is not limited to a fixed value or display; rather, it is freely programmable by the imaging means, so that moving images, text, symbols and/or characters can be displayed on, for example, a motor vehicle door or a side wall of the motor vehicle.

At least one light guide or light guide element is connected to the illuminating means, wherein light emitted by the illuminating means can be introduced into the light guide element. The light guide element can be a solid plastic or glass guide body, but the light guide or the light guide element can also be made of a flexible light-guiding material, such as a light-guiding flexible silicone. Other materials that can be used for the light-guiding elements include polystyrene or polymethyl methacrylate (PMMA). These are precisely the plastics that are characterized by good light-guiding properties.

By using the light guide or the light guide element, wherein these words are used as synonyms, it is possible to arrange parts of the lighting device outside the operating element in the motor vehicle and in particular the motor vehicle door. The light emitted by the light source or illuminating means is introduced into the light guide and guided to the imaging means. Of course, a reverse structure is also conceivable, wherein an imaging means is arranged directly behind the illuminating means and the light guide is connected to the imaging means. In any case, the combination of the light source, the light guide and the imaging means allows information to be displayed that can be projected onto an outer surface of the motor vehicle via the operating element. Here, a significant advantage has been found in that the operating element is arranged movably on the motor vehicle, so that the operating element can exit from the vehicle and a projection can be projected onto the outer surface, for example an outer body of the motor vehicle.

In particular, by using the imaging means as a variable display, it is possible to react to different states in the motor vehicle and, in addition to the variability of the display, to indicate the different states in the motor vehicle, for example by using different colors.

Characters and/or symbols and/or patterns can be displayed by means of the imaging means. By means of a representation of characters and/or symbols and/or patterns, it is possible to directly reproduce display states. The user of the motor vehicle is thus clearly informed if, for example, the motor vehicle is not in a properly closed state. This can also be done without prior knowledge, since it is possible to use characters and/or symbols to represent a text, for example, the meaning of which can be reinforced by a symbol. For example, a symbol can be a directional arrow, so that a visual aid can also be displayed for the user. For example, if a tailgate is not properly closed, a direction arrow may point to the rear of the vehicle. If, for example, the sliding roof is not fully closed, a symbol can be displayed, and in addition a text message can indicate that not all conditions for complete locking of the motor vehicle have been met, and a pattern can provide visual support, so that an intuitive and highly convenient safety and warning system is made available to the user. It is also conceivable that, for example, alternating and/or repeating symbols can provide a visual representation in the form of a moving image. For example, the closing of a side window can be indicated by visually indicating the closing process of the side window using varying, i.e., changing, symbols.

In an advantageous embodiment variant of the invention, at least one means for varying the light incident into the light guide is arranged between the illuminating means and the light guide. The illuminating means or light source sends light into the light guide, so that a projection is made possible. By means of the use of means for varying the light, it is now possible to configure the light. For example, an LCD or DLB panel and/or a polarization filter can be used for this purpose. A display offers the advantage of providing larger regions for displaying symbols and/or patterns and/or characters. Even if characters, patterns and symbols are mentioned here, this is not meant to be restrictive; rather, it is merely intended to point out by way of example that the display can be freely varied, i.e., it is not limited to characters, symbols and patterns, but rather capable of reproducing any desired motifs or forms of messages. By means of a display, it is possible to simultaneously present a plurality of indications or to present individual indications in a manner that is very readily understandable to the operator.

By means of one of the aforementioned freely programmable displays, it is possible not only to generate firmly specifiable text displays, but also to react individually to changes in the condition of the motor vehicle and to change the display immediately. Here, free programmability makes it possible, for example, to immediately display status changes in the motor vehicle. An LCD or DLP panel can be used advantageously, since this allows for free programmability and such panels are available in large numbers and at low cost.

A polarization filter can also be used as a light variation means in order to vary or influence the imaging. It is also conceivable that a combination of a panel and a polarization filter is used behind the light source. This makes it possible to generate different symbols and representations in a timed manner and in different forms.

It may also be advantageous and represent an embodiment of the invention if a means for deflecting the light, in particular a mirror or a prism, can be arranged in the operating element. By means of the mirror, a deflection of the light can be adjusted, so that even regions remote from the operating element can be illuminated, or projections can be generated in a manner spaced apart from the operating element. The deflection means can also interact with a polarization filter, so that the displays generated by means of the light source and, if applicable, the use of the light variation means can be deflected and separated. The use of different means for deflecting or varying the light makes a wide range of displays possible, wherein a plurality of displays having different content can also be shown or projected using the operating element. Depending on the application, for example an LCD panel in combination with a mirror, different displays can be created and, if different colored light sources are used, colored displays can also be created.

In order to achieve corresponding imaging as a function of the distance of the operating element from the outer surface of the motor vehicle, the use of at least one haptic, in particular an optic and/or a lens, may be advantageous. Due to the distance of the operating element from the surface when the operating element is extended, the size, light intensity and sharpness of the display can be varied by means of the optic, so that depending on the vehicle and type of use of the lighting device, it can be adapted to the area of application, i.e., the position of the lighting device in the motor vehicle.

Advantageously, deflection means in the form of controllable mirrors can also be used, wherein a laser is used advantageously as the light source. By means of the controllable mirrors and the use of a laser, it is also possible to project different motifs, characters and/or displays onto, for example, a B-pillar or the outer skin of a door.

By means of the aforementioned advantageous embodiment variants of the invention, a plurality of projections and/or images can be generated by means of the lighting device on the motor vehicle. For example, it is possible to generate different images at different locations on the motor vehicle by using two optics and a polarization filter along with a mirror. The light guide used can be designed as a rigid injection-molded part or, for example, as a flexible optical fiber in order to, for example, arrange the light source in a manner spaced apart from the light exit point on the operating element.

In one embodiment of the invention, it is conceivable if, for example, a polarization filter is used behind a light source and an LCD panel and in front of a deflecting mirror. The polarization filter can be switched in synchronization with the panel, so that two different projections can be transmitted to the mirror in a kind of time multiplex. If, for example, a further polarization filter synchronized with the first is used at the mirror, images that are generated independently of one another can also be separated, wherein a first image is guided further by a first optic and a further image can be guided further by a further optic.

In a further variant, it is also conceivable that the image is logically divided behind the LCD or DLP panel, so that, for example, the right half of the image is intended for a first optic and the left half of the image is guided further to a further optic. The mirror can be shaped in such a way that only the right part of the mirror reflects the right half of the image and the other part of the mirror transmits and projects the left half of the image. These are merely embodiment variants that can be realized with the aforementioned technical features of the subject matter of the invention. Primarily, however, the invention disclosure focuses on integrating an imaging means into a lighting device, wherein the lighting device is arranged in an operating element which is movably mounted on the motor vehicle. In particular, the movability of the operating element here makes it possible for a projection plane to be assumed in which the lighting device is capable of projecting information, spaced apart from the outer surface of the motor vehicle, onto a motor vehicle surface.

For the sake of completeness, it should be noted here that the mirror need not be a conventional mirror, but that, for example, a prism can also be used as the mirror. Moreover, instead of conventional mirrors, specially mirror-coated plastic parts can also be used.

In the following, the invention is explained in more detail with reference to the appended drawings using an exemplary embodiment. However, the principle applies that the exemplary embodiment does not limit the invention, but merely represents an advantageous embodiment. The features depicted can be implemented individually or in combination with further features of the description as well as the claims—individually or in combination.

In the drawings:

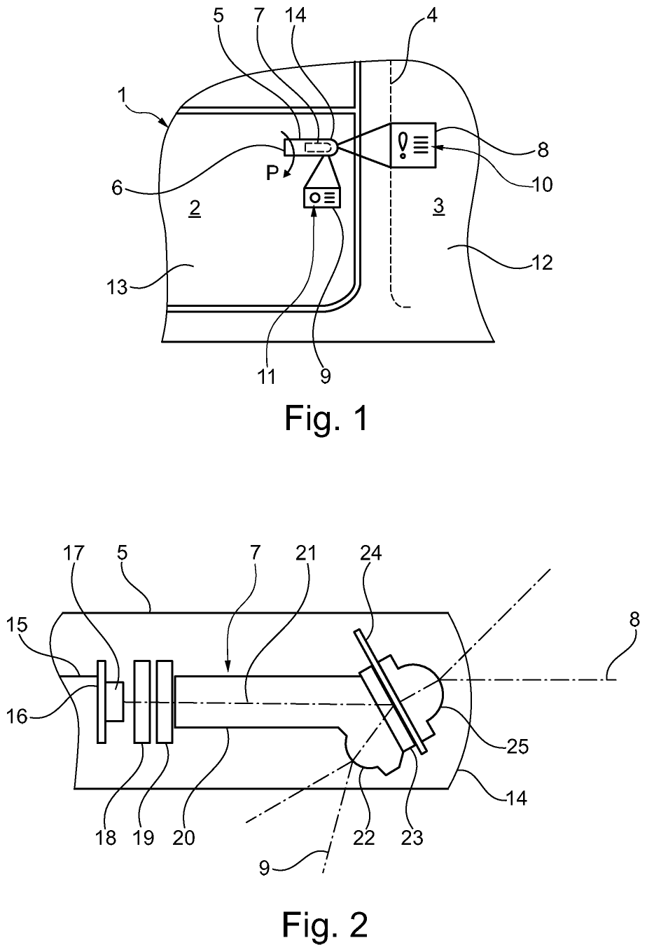

FIG. 1 shows a side view of a motor vehicle in the region of an outer door handle, wherein a side door in combination with a B-pillar and a side wall is shown, and

FIG. 2 shows a detailed view of an operating element designed according to the invention having a basic representation of a lighting device integrated into the operating element.

FIG. 1 is a side view of a motor vehicle 1 in a view of a motor vehicle door 2 and a view of a side wall 3 of the motor vehicle 1. In this embodiment, the side wall 3 also contains the B-pillar 4 of the motor vehicle 1. The motor vehicle side door 1 is shown in a closed position. Starting from the closed position, it is possible for the outer door handle 5 to move out of the motor vehicle, for example by approaching the motor vehicle 1 and/or by a command from the vehicle operator. For this purpose, the outer door handle 5 can be pivoted out, for example, about a pivot axis 6, wherein the pivoting movement is indicated by the arrow P. The pivoting movement can preferably be carried out horizontally, but it is also possible for the pivoting movement of the outer door handle 5 to be executed in a vertical direction in FIG. 1, upwards or downwards. The outer door handle 5 is assigned a lighting device 7, wherein the lighting device 7 is capable of generating displays 8, 9. The displays 8, 9 can be displayed as symbols or text 10, 11 on a surface 12 or an outer skin 13 of the side door 2. In any case, by means of the lighting device 7, a display 8, 9 can be projected in different directions onto the vehicle surface 12 and/or the outer skin 13 of the side door. It is advantageous that the operating element 5 moves out of the motor vehicle 1, so that an outer end 14 of the operating element 5 is arranged in a manner spaced apart from the surface 12, 13 of the motor vehicle 1. Even when the side door 2 is not opened, information is available to the operator in the form of a projection on the vehicle surface 12, 13.

FIG. 2 now shows, by way of example, the structure of the lighting device 7 in the operating element 5. By means of the dot-dash lines, the displays 8, 9 can be recognized, which are projected by the lighting device 7 onto the vehicle surface 12 and the outer skin 13 of the side door 2. FIG. 2 shows the extended or at least moved operating element 5 in a position spaced apart from the vehicle surface 12 and the outer skin 13, so that a projection of the displays 8, 9 is made possible.

A power or control line 15 supplies a circuit board or control unit 16 with a voltage or a control signal, so that a light source or a illuminating means 17 can be actuated or energized. Behind the light source 17, an LCD (liquid crystal display) panel is arranged, by way of example, with which changeable displays, symbols or characters can be generated. A polarization filter 19 is arranged behind the LCD display 18, with which either a clocked imaging or a variable imaging can be adjusted. A light guide 20 is connected downstream of the polarization filter 19, so that a light 21 generated by the illuminating means 17 can be guided further. The light is shown by way of example only as a dot-dash line in the lighting device 7. A first optic 22 is assigned to the light guide 20, wherein the light guide 20 and the first optic 22 can also be produced as a single piece as a rigid plastic injection-molded part. By way of example, a polarization filter 23 is again arranged downstream of the light guide 20. Behind the polarization filter 23, a mirror 24 is arranged in the operating element 5. By means of the mirror 24 in combination with the polarization filter 23, the light can be reflected and thus the display 9 can be generated. Depending on the interaction of the polarization filter 23 and the mirror 24, the light 21 is further guided to a second optic 25, so that the further display 8 can be generated on the motor vehicle 1.

By means of a clocked interaction of the light source, LCD display, polarization filter 19, 23 and mirror 24, images in the displays 8, 9 can be separated and different displays 8, 9 can be shown in different regions of the motor vehicle 1. However, it should be pointed out again here that this exemplary embodiment is not limiting, but rather that different displays can be generated from the technical features of the invention mentioned, wherein it is also pointed out by way of example that a laser, for example, can be used as the illuminating means 17, which in turn can generate displays 8, 9 on the vehicle surface 12 and/or the outer skin 13 via a movable mirror and a corresponding actuation of the movable mirror.

List of reference signs

| | |
|---|---|
| 1 | Motor vehicle |
| 2 | Motor vehicle side door |
| 3 | Side wall |
| 4 | B-pillar |
| 5 | Outer door handle, operating element |
| 6 | Pivot axis |
| 7 | Lighting device |
| 8, 9 | Display |
| 10, 11 | Symbol, text |
| 12 | Vehicle surface |
| 13 | Outer skin |
| 14 | Outer end |
| 15 | Power, control line |
| 16 | Circuit board, control unit |
| 17 | Illuminating means |
| 18 | LCD panel |
| 19, 23 | Polarization filter |
| 20 | Light guide |
| 21 | Light |
| 22, 25 | Optic |
| 24 | Mirror |
| P | Arrow |

1. A lighting device on a vehicle door of a motor vehicle, having an illuminating means, a light guide which can be connected to the illuminating means and an imaging means, wherein by means of the lighting device a variable display can be generated, wherein the lighting device is arranged at least partly in an operating element that can be moved out of the vehicle.

2. The lighting device according to claim 1, wherein the illuminating means is arranged in a manner spaced apart from the operating element in the vehicle type.

3. The lighting device according to claim 1, wherein at least one means for varying the light incident into the light guide is arranged between the illuminating means and the light guide.

4. The lighting device according to claim 3, wherein the light variation means is an LCD or DLP panel and/or a polarization filter.

5. The lighting device according to claim 1, wherein a means for deflecting the light, in particular a mirror or a prism, can be arranged in the operating element.

6. The lighting device according to claim 5, wherein the deflection means can be designed as a movably controllable mirror.

7. The lighting device according to claim 5, wherein the deflection means interact with a polarization filter, so that the display generated by means of the light source and the light variation means can be separated.

8. The lighting device according to claim 1, wherein the lighting device has at least one optic, in particular an optic and a lens.

9. The lighting device according to claim 1, wherein the illuminating means is an LED, in particular a color-changeable LED, or a laser.

10. The lighting device according to claim 1, wherein the light guide can be designed as a rigid or flexible light guide.
